(19) United States
(12) Patent Application Publication
(10) Pub. No.: US 2006/0000924 A1
(43) Pub. Date: Jan. 5, 2006

(54) Pump-nozzle unit and method for regulating the opening pressure of the same

(76) Inventors: Maximilian Kronberger, Regensburg (DE); Dejan Jovovic, Regensburg (DE); Leonhard Trapp, Berlin (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/156,944

(22) Filed: Jun. 20, 2005

Related U.S. Application Data
(63) Continuation of application No. PCT/DE03/04094, filed on Dec. 11, 2003.

(30) Foreign Application Priority Data
Dec. 20, 2002 (DE) 2002 10260346.4

(51) Int. Cl. F02M 47/02

(52) U.S. Cl. 239/88

(57) ABSTRACT

A pump-nozzle unit for feeding fuel into a combustion chamber of an internal combustion engine, the pump-nozzle unit comprises: a fuel injection nozzle, which has a nozzle needle which can move in reciprocating fashion between a closed position and an open position, a spring, which exerts a closure force, the level of which depends on a prestressing force exerted on the spring, on the nozzle needle, and a first pressure space, to which a first pressure can be applied, with an opening force being exerted on the nozzle needle by the first pressure. The method comprises the following steps, which are carried out simultaneously: applying a first pressure to the first pressure space, and varying the prestressing force exerted on the spring until a selected prestressing force, at which the nozzle needle moves into the open or closed position at the desired level of the first pressure, is reached.

### CROSS-REFERENCE TO RELATED APPLICATION

This application is a continuation of copending International Application No. PCT/DE03/04094 filed Dec. 11, 2003 which designates the United States, and claims priority to German Application No. 2002 10260346.4 filed Dec. 20, 2002.

### TECHNICAL FIELD

The invention relates to a method for setting the nozzle opening pressure of a pump-nozzle unit for feeding fuel into a combustion chamber of an internal combustion engine, the pump-nozzle unit having: a fuel injection nozzle, which has a nozzle needle which can move in reciprocating fashion between a closed position and an open position, a spring, which exerts a closure force, the level of which depends on a prestressing force exerted on the spring, on the nozzle needle, and a first pressure space, to which a first pressure can be applied, with an opening force being exerted on the nozzle needle by the first pressure. Furthermore, the invention relates to a pump-nozzle unit for feeding fuel into a combustion chamber of an internal combustion engine, in particular a pump-nozzle unit whereof the nozzle opening pressure has been set using the method according to the invention, having a fuel injection nozzle, which has a nozzle needle which can move in reciprocating fashion between a closed position and an open position, and a spring, which exerts a closure force, the level of which depends on a selected prestressing force exerted on the spring, on the nozzle needle.

### BACKGROUND

Pump-nozzle units of this type are used in particular in combination with pressure-controlled injection systems. One significant feature of a pressure-controlled injection system consists in the fact that the fuel injection nozzle opens as soon as an opening force, which is influenced at least by prevailing pressures, is exerted on the nozzle needle. Pressure-controlled injection systems of this type are used for fuel metering, fuel preparation, the shape of the injection profile and to seal off the supply of fuel with respect to the combustion chamber of the internal combustion engine. Pressure-controlled injection systems allow the time profile of the quantitative flow during the injection to be controlled in an advantageous way. This allows the power, fuel consumption and pollutant emissions of the engine to be influenced in a positive way.

In the pump-nozzle units of the generic type, the fuel pump and the fuel injection nozzle are formed as an integrated component. For each combustion chamber of the internal combustion engine, there is at least one pump-nozzle unit, which is generally installed in the cylinder head. The fuel pump typically comprises a fuel pump piston which can move in reciprocating fashion in a fuel pump cylinder and is driven either directly by means of a tappet or indirectly by means of rocker levers of a camshaft of the internal combustion engine. That portion of the fuel pump cylinder which usually forms a second pressure space can be connected via a control valve to a fuel low-pressure region, when the control valve is open, fuel is sucked into the second pressure space from the fuel low-pressure region, and if the control valve stays open, this fuel is then forced back from the second pressure space into the fuel low-pressure region. As soon as the control valve is closed, the fuel pump piston compresses the fuel which is present in the second pressure space, and thereby builds up the pressure. The second pressure space is in communication with a first pressure space, with a first pressure, prevailing in the first pressure space, exerting an opening force on the nozzle needle, for example on a portion of the nozzle needle which has a shoulder.

The first pressure, which prevails in the first pressure space and at which the nozzle needle opens and an injection takes place, is referred to as the nozzle opening pressure. To satisfy the functional demands imposed on a pump-nozzle unit, it is necessary to set the nozzle-opening pressure; the higher the nozzle-opening pressures, the more accurate the setting tolerance needs to be. To set the nozzle opening pressure, it is known to preassemble at least the component which accommodates the spring and the spring as well as the fuel injection nozzle on a base disk, and then to measure the actual nozzle-opening pressure on a pressure test bench. The required thickness of a washer which is fitted in the pump-nozzle unit in order to prestress the spring and therefore to change the nozzle-opening pressure, can be calculated from the measured actual nozzle-opening pressure, a predetermined desired nozzle-opening pressure and the spring constant of the spring. In the prior art, the pump-nozzle unit has to be at least partially dismantled in order for the washer to be fitted, and then reassembled after the adjustment washer has been fitted. In many cases, it is then necessary for the nozzle-opening pressure, which has been altered by the washer being fitted, to be tested again on the pressure test bench. If the desired nozzle-opening pressure is not achieved with the fitted washer, it is necessary for the pump-nozzle unit to be dismantled again and for a washer of a different thickness to be fitted.

The method explained above is very complex, on account of the dismantling and assembly steps required and the measurement of the actual nozzle-opening pressure, which is separate from the dismantling and assembly steps in terms of time, and therefore entails high costs.

### SUMMARY

The invention is based on the object of developing the methods of the generic type and the pump-nozzle units of the generic type in such a manner that an exact nozzle-opening pressure is ensured in an inexpensive way.

This object can be achieved by a method for setting the nozzle opening pressure of a pump-nozzle unit for feeding fuel into a combustion chamber of an internal combustion engine, the pump-nozzle unit having a fuel injection nozzle, which has a nozzle needle which can move in reciprocating fashion between a closed position and an open position, a spring, which exerts a closure force, the level of which depends on a prestressing force exerted on the spring, on the nozzle needle, and a first pressure space, to which a first pressure can be applied, with an opening force being exerted on the nozzle needle by the first pressure, in which the following steps are carried out simultaneously:—applying a first pressure to the first pressure space,—varying the prestressing force exerted on the spring until a selected prestressing force, at which the nozzle needle moves into the open or closed position at the desired level of the first pressure, is reached, wherein the end portion of the spring is locked in the selected position by a prestressing element used in the pump-nozzle unit which forces the end portion of the spring into the selected position, the prestressing element is locked in a selected position in order to force the end portion of the spring into the selected position, and the prestressing element is locked in its selected position by frictional locking; and wherein the prestressing element is designed as a conical stopper, and the prestressing element is arranged in a conical portion of the pump-nozzle unit.

An end portion of the spring can be locked in a selected position which the end portion of the spring adopts when the selected prestressing force is exerted on the spring. The dimensions of the prestressing element can be suitable for forcing the end portion of the spring into the selected position. The prestressing element can be locked in its selected position by positive locking. The prestressing element can be deformed in order to achieve the frictional and/or positive lock. The prestressing element can be designed in the form of a sleeve or a slotted sleeve. The prestressing element can be designed in the form of a cup with a hole provided in its base. The prestressing force can be varied by changing the position of the prestressing element. The prestressing force can be varied by changing the position of a mandrel.

The object can also be achieved by a pump-nozzle unit for feeding fuel into a combustion chamber of an internal combustion engine, comprising a fuel injection nozzle, which has a nozzle needle which can move in reciprocating fashion between a closed position and an open position, and a spring, which exerts a closure force, the level of which depends on a selected prestressing force exerted on the spring, on the nozzle needle, wherein the level of the selected prestressing force is dependent on a selected position of a prestressing element which is locked in the pump-nozzle unit, wherein the prestressing element forces an end portion of the spring into a selected position and wherein the prestressing element is locked in its selected position by frictional locking, and wherein the prestressing element is designed as a conical stopper, and the prestressing element is arranged in a conical portion of the pump-nozzle unit.

The prestressing element can be deformed in order to achieve the frictional and/or a positive lock. The prestressing element can be designed in the form of a sleeve or a slotted sleeve. The prestressing element can be designed in the form of a cup with a hole in its base.

The method according to the invention builds on the generic prior art by virtue of including the following steps, which are carried out simultaneously: applying a first pressure to the first pressure space, and varying the prestressing force exerted on the spring until a selected prestressing force, at which the nozzle needle moves into the open or closed position at the desired level of the first pressure, is reached. In this context, in addition to the prestressing force exerted on the spring, it is if appropriate also possible to vary the first pressure, should this prove advantageous. Furthermore, it should be borne in mind that the first pressure for setting the nozzle-opening pressure is preferably not generated by means of the fuel pump assigned to the pump-nozzle unit at least in the ready-to-operate state, but rather is generated externally. The movement of the nozzle needle into the open or closed position can, for example, be detected directly and/or by means of the profile of the first pressure. The method according to the invention makes it possible to set the nozzle-opening pressure very accurately without (repeated) dismantling and assembly steps, and results in a stable pump function. Furthermore, the method according to the invention can be carried out completely automatically at least in preferred embodiments.

In preferred embodiments of the method according to the invention, it is also provided that an end portion of the spring is locked in a selected position which the end portion of the spring adopts when the selected prestressing force is exerted on the spring. The locking of the end portion of the spring is preferably likewise fully automatic, either while the selected prestressing force is being determined or thereafter.

In the context outlined above, a preferred refinement of the method according to the invention provides that the locking of the end portion of the spring in the selected position is effected by a prestressing element which is inserted into the pump-nozzle unit and forces the end portion of the spring into the selected position. To force the end portion of the spring into the selected position, the prestressing element can act either directly or indirectly, for example via a further element, on the end portion of the spring.

In certain embodiments of the method according to the invention, it is possible to provide that the dimensions of the prestressing element are suitable for forcing the end portion of the spring into the selected position. A pump-nozzle unit whereof the nozzle-opening pressure has been set in accordance with this embodiment, in the fully assembled state, under certain circumstances cannot be distinguished from a pump-nozzle unit whereof the nozzle-opening pressure has been set using the known method explained in the introduction. Nevertheless, even this embodiment of the method according to the invention can be carried out very much more easily than the known methods, since the appropriate dimensions of the prestressing element, unlike in the prior art, do not have to be calculated by means of the spring constant of the spring and so on, but rather can be determined directly, for example by length measurement or hydraulic opening pressure measurement, so that repeated dismantling and assembly can be avoided under all circumstances.

However, in preferred embodiments of the method according to the invention, it is provided that the prestressing element is locked in a selected position in order to force the end portion of the spring into the selected position. Since in this case the prestressing element is locked in a selected position, which ensures the selected prestressing force, with this embodiment it is not necessary to provide prestressing elements with defined length classes.

In the context explained above, it is particularly preferable for the prestressing element to be locked in its selected position by frictional and/or positive locking. A frictional lock is particularly preferred, for example a frictional lock with a coefficient of friction of 0.1÷0.2.

If appropriate, in the context explained above, it is also possible to provide that the prestressing element be deformed in order to achieve the frictional and/or positive lock. Deformation of this type can be achieved, for example, by pressing the prestressing element into a conical portion of the spring chamber.

Furthermore, it may be advantageous for the prestressing element to be designed in the form of a sleeve or a slotted sleeve.

In addition or as an alternative, it is possible to use embodiments in which it is provided that the prestressing element is designed in the form of a cup with a hole in its base.

Furthermore, it is possible to provide that the prestressing element be of conical design at least in portions.

As has already been indicated above, in certain embodiments of the method according to the invention, it is also possible to provide that the prestressing element be arranged in a conical portion of the pump-nozzle unit.

According to a first preferred embodiment of the method according to the invention, it is provided that the prestressing force is varied by changing the position of the prestressing element. For this purpose, the prestressing element can be pressed continuously or in steps into the spring chamber, for example with the aid of a draw-in ram, until the desired nozzle-opening pressure results. The force which is required to press in the prestressing element is in this case preferably significantly higher than the selected prestressing force. This can be ensured, for example, by providing a suitable coefficient of sliding friction or suitable add on friction value.

In an alternative embodiment of the method according to the invention, it is provided that the prestressing force is varied by changing the position of a mandrel. In this embodiment it is possible, for example, to provide that the draw-in ram which is provided for pressing in the prestressing element has a bore through which the mandrel extends, it being possible for an end portion of the mandrel to act directly or indirectly on the end portion of the spring. With this solution, it is possible to increase the prestressing force in order to determine the selected prestressing force and then also to reduce it again. The mandrel may act on the end portion of the spring, for example via a perforated disk. The prestressing element is preferably only moved into its final selected position by the draw-in ram when the selected prestressing force has been determined.

The pump-nozzle unit according to the invention builds on the generic prior art by virtue of the fact that the level of the selected prestressing force is dependent on a selected position of a prestressing element in which the prestressing element is locked in the pump-nozzle unit. The pump-nozzle units according to the invention differ from the known pump-nozzle units by virtue of the fact that the level of the selected prestressing force is defined not by a prestressing element with defined dimensions, for example a washer with a defined thickness, but rather by means of the location or position of the prestressing element in the pump-nozzle unit. Pump-nozzle units of this type can be produced at lower cost than the known pump-nozzle units, since the setting of the nozzle-opening pressure can be carried out at low cost by means of the position of the prestressing element, for example by means of the method according to the invention.

In the pump-nozzle unit according to the invention, it is preferably also provided that the prestressing element forces an end portion of the spring into a selected position.

In preferred embodiments of the pump-nozzle unit according to the invention, it is also provided that the prestressing element be locked in its selected position by frictional and/or positive locking.

In this context, it is also possible to provide that the prestressing element be deformed in order to achieve the frictional and/or positive lock.

Similarly to the method according to the invention, the pump-nozzle unit according to the invention also encompasses embodiments in which it is provided that the prestressing element be designed in the form of a sleeve or a slotted sleeve.

Alternatively, it is possible to provide for the prestressing element to be designed in the form of a cup with a hole in its base.

With the pump-nozzle unit according to the invention, it is likewise possible to provide for the prestressing element to be of conical design at least in portions.

In addition or as an alternative, it is possible to provide that the prestressing element be arranged in a conical portion of the pump-nozzle unit.

The discovery that the nozzle-opening pressure can be set very accurately and at low cost if the prestressing force of the spring when pressure is applied to the first pressure space is varied until the desired injection properties are achieved, is crucial to the invention.

### BRIEF DESCRIPTION OF THE DRAWINGS

The invention will now be explained by way of example with reference to the appended drawings and on the basis of preferred embodiments.

FIG. 1 diagrammatically depicts an embodiment of the pump-nozzle unit according to the invention.

FIG. 2 shows a diagrammatic illustration presenting the setting of the nozzle-opening pressure in accordance with a first embodiment of the method according to the invention.

FIG. 3a shows a graph illustrating a possible profile of the prestressing force exerted on the spring as a function of time for the first embodiment of the method according to the invention.

FIG. 3b shows a graph illustrating a possible profile for the pump pressure as a function of time for the first embodiment of the method according to the invention.

FIG. 3c shows a graph illustrating a possible profile of the first pressure and the opening and closing characteristics of the nozzle needle as a function of time, for the force profile illustrated in FIG. 3a and the pressure profile illustrated in FIG. 3b.

FIG. 3d shows the injection characteristics of the pump-nozzle unit as a function of time, for the force profile illustrated in FIG. 3a and the pressure profile illustrated in FIG. 3b.

FIG. 4 shows a diagrammatic illustration presenting the setting of the nozzle-opening pressure in accordance with a second embodiment of the method according to the invention.

FIG. 5a shows a graph illustrating a possible profile of the prestressing force exerted on the spring as a function of time for the second embodiment of the method according to the invention.

FIG. 5b shows a graph illustrating a possible profile for the pump pressure as a function of time for the second embodiment of the method according to the invention.

FIG. 5c shows a graph illustrating a possible profile for the first pressure and the opening and closing characteristics of the nozzle needle as a function of time, for the force profile illustrated in FIG. 5a and the pressure profile illustrated in FIG. 5b.

FIG. 5d shows the injection characteristics of the pump-nozzle unit as a function of time, for the force profile illustrated in FIG. 5a and the pressure profile illustrated in FIG. 5b.

FIG. 6a shows a graph illustrating a possible profile of the prestressing force exerted on the spring as a function of time for a third embodiment of the method according to the invention.

FIG. 6b shows a graph illustrating a possible profile for the pump pressure as a function of time for the third embodiment of the method according to the invention.

FIG. 6c shows a graph which illustrates a possible profile for the first pressure and the opening and closing characteristics of the nozzle needle as a function of time, for the force profile illustrated in FIG. 6a and the pressure profile illustrated in FIG. 6b.

FIG. 6d shows the injection characteristics of the pump-nozzle unit as a function of time, for the force profile illustrated in FIG. 6a and the pressure profile illustrated in FIG. 6b.

FIG. 7 diagrammatically depicts a prestressing element in the form of a sleeve or a slotted sleeve.

FIG. 8 diagrammatically depicts a prestressing element in the form of a deep-drawn or extruded and perforated cup.

FIG. 9 diagrammatically depicts a prestressing element in the form of a conical stopper.

### DETAILED DESCRIPTION

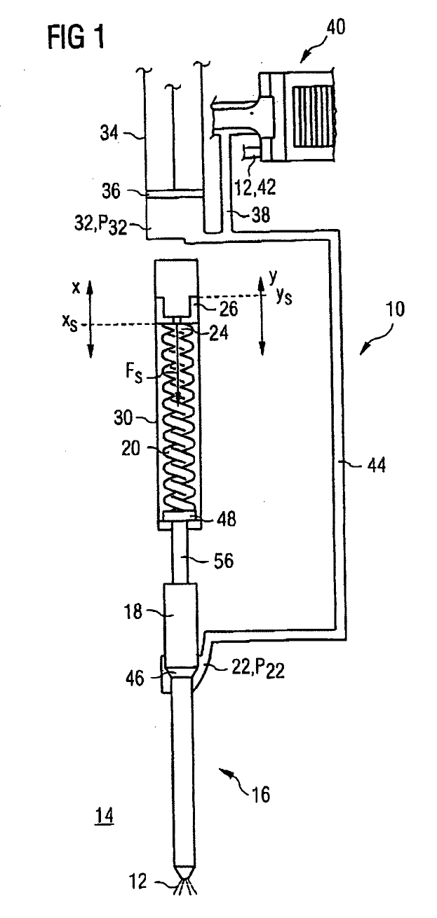

FIG. 1 shows a diagrammatically depicted embodiment of the pump-nozzle unit according to the invention. The pump-nozzle unit 10 illustrated, for feeding fuel 12 into a combustion chamber 14 of an internal combustion engine, has a fuel pump 32-40. A fuel pump piston 36 can move in reciprocating fashion in a fuel pump cylinder 34. The fuel pump piston 36 is driven directly or indirectly via a camshaft (not shown) of the internal combustion engine. The compression space of the fuel pump cylinder 34 forms a second pressure space 32. The second pressure space 32 is connected to a piezoelectrically operated control valve 40, which is known per se, via a fuel line 38. The control valve 40 is used to either close the fuel line 38 or connect it to a fuel low-pressure region 42, from which fuel 12 can be sucked up. In its open at-rest position, in the event of an upwardly directed movement of the fuel pump piston 36, as seen in FIG. 1, fuel 12 is sucked out of the fuel low-pressure region 42 into the second pressure space 32. Provided that the control valve 40 is still in its open at-rest position in the event of a downwardly directed movement of the fuel pump piston 36, as seen in FIG. 1, fuel 12 which has previously been sucked into the second pressure space 32 can be forced back into the fuel low-pressure region 42. If the control valve 40 is actuated, it closes the fuel line 38. As a result, the fuel 12 which has been sucked into the second pressure space 32 is compressed in the event of a downwardly directed movement of the fuel pump piston 36, thereby generating the second pressure p₃₂ in the second pressure space 32. The pump-nozzle unit 10 illustrated also comprises a fuel injection nozzle, which is denoted overall by 16 and has a nozzle needle 18 which can move in reciprocating fashion between a closed position and an open position. The upper end portion of the nozzle needle 18, as seen in FIG. 1, has a disk 48 and a guide pin 56, which in the embodiment illustrated in FIG. 1 is guided in a spring chamber 30. A spring 20 is arranged in the spring chamber 30 and exerts a downwardly directed closure force on the disk 48 and the guide pin 56 and therefore the nozzle needle 18. The upper end portion 24 of the spring 20 is supported against a cup-shaped prestressing element 26, which is locked in a selected position Y_{S} in the spring chamber 30. The selected position Y_{S} of the closure element 26, which is referenced to the upper edge of the closure element 26 in FIG. 1, forces the end portion 24 of the spring 20 into a selected position X_{S}. The selected position Y_{S} of the closure element 26 or the selected position X_{S} of the end portion 24 of the spring 20 is used to set a selected prestressing force F_{S} which is exerted on the spring 20. The level of this selected prestressing force F_{S} influences the nozzle-opening pressure, as will be explained in more detail below. A first pressure space 22 surrounds a portion of the nozzle needle 18 which has a shoulder 46. The first pressure space 22 is in communication with the second pressure space 32 via a connecting line 44. Therefore, fuel which is at a first pressure P₂₂ in the first pressure space 22 exerts an opening force on the nozzle needle 18. This opening force counteracts the closure force exerted by the spring 20 on the disk 48 and the guide pin 56. It can be seen that the selected position Y_{S} of the prestressing element 26 or the selected position X_{S} of the end portion 24 of the spring 20 defines the level of the first pressure P_{22S} required in the first pressure space 22, which leads to the nozzle needle 18 opening and therefore to an injection operation. The closure element 26 is locked in the spring chamber 30 by frictional locking; by way of example, it is possible to provide for a coefficient of friction of 0.1÷0.2. Although this is not illustrated in FIG. 1, the closure element 26 and/or the spring chamber 30 may be conical in form at least in portions, in order to facilitate locking of the closure element 26 in the spring chamber 30. Furthermore, although this is likewise not illustrated, it is also possible for a pressure to be applied to the spring chamber 30 and/or another region of the pump-nozzle unit, in order to influence the opening behavior of the nozzle needle 18. By way of example, a pressure prevailing in the spring chamber 30, in addition to the closure force generated by the spring 20, would exert a further closure force on the disk 48 and the guide pin 56. The method according to the invention can advantageously be used to determine the selected position Y_{S} of the prestressing element 26 and to lock the prestressing element 26 in this position, as will be explained in more detail below.

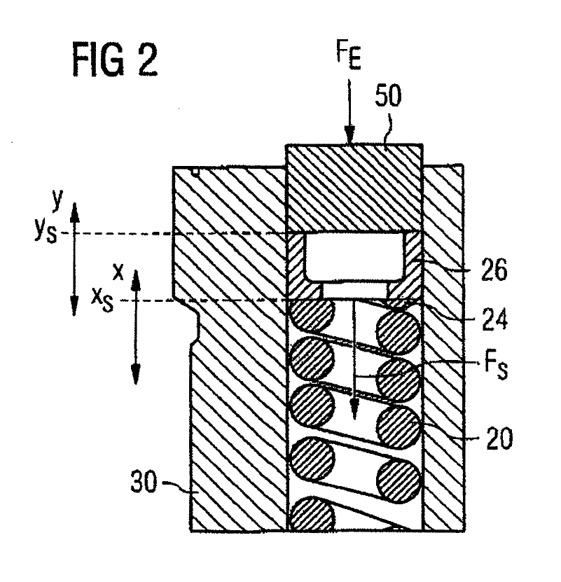

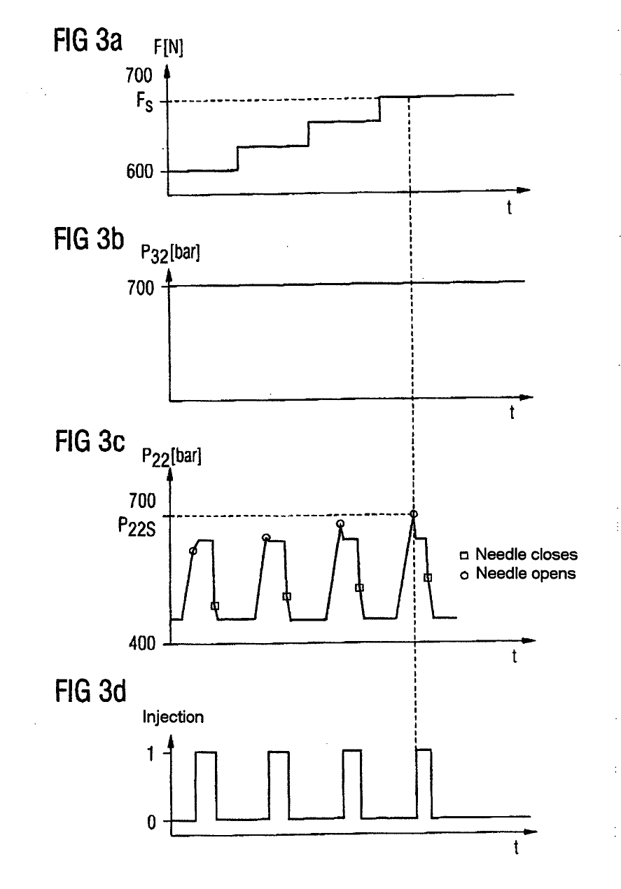

FIG. 2 shows a diagrammatic illustration of the setting of the nozzle-opening pressure in accordance with a first embodiment of the method according to the invention. In this embodiment, a spring 20, the lower end portion (not shown) of which exerts a closure force on a nozzle needle, is arranged in a spring chamber 30, only part of which is illustrated. A prestressing element 26, which is designed in the form of a perforated cup, forces the upper end portion 24 of the spring 20 into a selected position X_{S} and exerts a selected prestressing force F_{S} on the spring 20. The arrangement is selected in such a manner that the prestressing element 26 can be pressed into the spring chamber 30 by a draw-in ram 50, the force F_{E} which is required to do this being significantly higher than the selected prestressing force F_{S}. In other words, the prestressing element 26 is frictionally locked in the spring chamber 30 with respect to the selected prestressing force F_{S}, but can be pressed further into the spring chamber 30 by a significantly higher force F_{E} exerted via the draw-in ram 50. Based on the illustration presented in FIG. 2, the prestressing element 26 is pushed or pressed down into the spring chamber 30 until it adopts a selected position Y_{S} in which the end portion 24 of the spring 20 is fixed in a selected position X_{S}, in which the selected prestressing force F_{S} is exerted on the spring 20. The setting of the selected prestressing force F_{S} is explained in more detail below with reference to FIGS. 3a to 3d.

FIG. 3a shows a graph illustrating a possible profile of the prestressing force exerted on the spring as a function of time for the first embodiment of the method according to the invention, FIG. 3b shows a graph illustrating a possible profile for the pump pressure as a function of time for the first embodiment of the method according to the invention, FIG. 3c shows a graph illustrating a possible profile for the nozzle-space pressure or the first pressure and the opening and closing characteristics of the nozzle needle as a function of time, for the force profile illustrated in FIG. 3a and the pressure profile illustrated in FIG. 3b, and FIG. 3d shows the injection characteristics of the pump-nozzle unit as a function of time, for the force profile illustrated in FIG. 3a and the pressure profile illustrated in FIG. 3b. It can be seen from FIG. 3b that the system is subject to a constant second pressure p₃₂ of, in the case illustrated, 700 bar during the setting operation. The second pressure p₃₂ for setting the nozzle-opening pressure is generated not by the fuel pump 32 to 42 (cf FIG. 1), but rather externally. It can be seen from the illustration represented in FIG. 3a that the prestressing force exerted on the spring 20 is increased in steps. Based on the illustration presented in FIG. 2, the prestressing force F is increased by moving the draw-in ram 50 downward in steps, so that the spring 20 is prestressed further in steps by means of the prestressing element 26. FIG. 3c shows the profile of the first pressure p₂₂ within the first pressure space 22 (cf. FIG. 1). FIG. 3c also shows the opening and closing characteristics of the nozzle needle, the first pressure p₂₂ at which the nozzle needle opens and also the first pressure p₂₂ at which the nozzle needle closes again increasing as the prestressing force rises. The period of time between the nozzle needle 18 opening and closing in each case defines the duration of an injection, as can be seen from FIG. 3d. The prestressing force F is increased in steps until the nozzle needle 20 opens at a selected first (opening) pressure p_{22S}. The prestressing force F which is exerted on the spring 20 at this time corresponds to the selected prestressing force F_{S}. As soon as this selected prestressing force F_{S} has been reached, the draw-in ram 50 (cf FIG. 2) can be removed, since the prestressing element 26 is in its selected position Y_{S}, in which it locks the end portion 24 of the spring 20 in the selected position X_{S} thereof. As an alternative to increasing the prestressing force F in steps, as illustrated in FIG. 3a, it is also possible for the prestressing force F to be increased continuously.

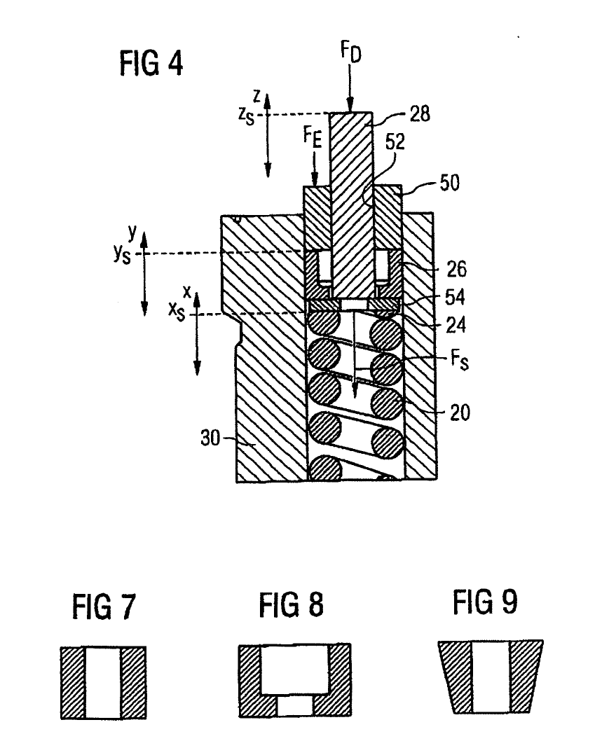

FIG. 4 shows a diagrammatic illustration of the setting of the nozzle-opening pressure in accordance with a second embodiment of the method according to the invention. In this embodiment too, a spring 20 is arranged in a spring chamber 30, only part of which is illustrated; the lower end portion (not shown) of this spring 20 exerts a closure force on a nozzle needle 18. A perforated disk 54 is arranged between a prestressing element 26 and the upper end portion 24 of the spring 20. The prestressing element 26 is designed in the form of a perforated cup, with a mandrel 28 extending through the recess in the prestressing element 26 and thereby being able to exert a prestressing force F on the perforated disk 54 and therefore the spring 20. The mandrel 28 furthermore extends through a hole 52 provided in a draw-in ram 50, in such a manner that the mandrel 28 can be moved up and down in a direction Z independently of the draw-in ram 50. In accordance with the illustration presented in FIG. 4, the prestressing element 26 is already in its selected position Y_{S}, in which the upper end portion 24 of the spring 20 is forced into its selected position X_{S} via the perforated disk 54. During the determination of the selected prestressing force F_{S} or of the selected position X_{S}, the prestressing element 26 and the draw-in ram 50 are arranged further upward than in the illustration presented in FIG. 4, so that the mandrel 28 can be moved up and down independently of the draw-in ram 50 and the prestressing element 26, until the mandrel 28 is in a selected position Z_{S}, in which the selected prestressing force F_{S} is exerted on the spring 20. As soon as the mandrel 28 has adopted its selected position Z_{S}, in which the end portion 24 of the spring 20 is in its selected position X_{S}, the draw-in ram 50, and with it the prestressing element 26, are moved downward by a force F_{E}, which must preferably be significantly higher than the selected prestressing force F_{S}, being exerted on the draw-in ram 50 in order to move the prestressing element 26. Then, the mandrel 28 and the draw-in ram 50 can be removed, since the prestressing element 26 has been frictionally locked in the spring chamber 30 with respect to the prestressing force F_{S}.

As an alternative to locking the prestressing element 26 in the spring chamber 30, it is also possible, for example, to record the distance which the mandrel 28 has moved into the spring chamber 30 by the time the selected prestressing force F_{S} is reached, and then to fit a prestressing element of a defined length, which ensures the selected position X_{S} of the end portion 24 of the spring 20. However, the following explanation of the determining and setting of the selected prestressing force F_{S} relates to an embodiment of the invention in which a prestressing element 26 which is locked in a selected position Y_{S} in the spring chamber 30 is used, in accordance with the illustration presented in FIG. 4.

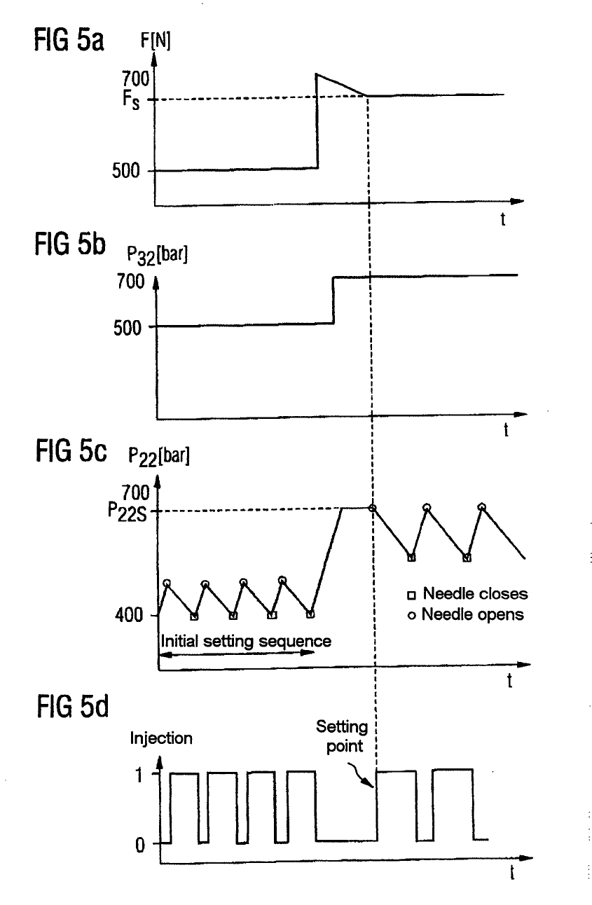

FIG. 5a shows a graph illustrating a possible profile of the prestressing force exerted on the spring as a function of time for the second embodiment of the method according to the invention, FIG. 5b shows a graph illustrating a possible profile for the pump pressure as a function of time for the second embodiment of the method according to the invention, FIG. 5c shows a graph illustrating a possible profile for the first pressure and the opening and closing characteristics of the nozzle needle as a function of time, for the force profile illustrated in FIG. 5a and the pressure profile illustrated in FIG. 5b, and FIG. 5d shows the injection characteristics of the pump-nozzle unit as a function of time, for the force profile illustrated in FIG. 5a and the pressure profile illustrated in FIG. 5b. In this embodiment too, the second pressure p₃₂ in the second pressure space 32 is preferably provided by an external pressure source, in order to determine the selected prestressing force F_{S} and/or set the nozzle-opening pressure to p_{22S}. As can be seen from a comparison of FIGS. 5b and 5c, first of all an initial setting sequence is carried out, during which the nozzle needle 18 opens and closes a number of times (cf. FIG. 5c). For this purpose, a second pressure p₃₂ of 500 bar is applied to the system (cf. FIG. 5b). At the same time, a relatively low prestressing force of 500 N is exerted on the spring 20 via the mandrel 28 in accordance with FIG. 4. Then, both the second pressure p₃₂ and the prestressing force F are increased; to increase the prestressing force F, the mandrel 28 is moved further downward with respect to the illustration presented in FIG. 4. At this time, the draw-in ram 50 and the prestressing element 26 from FIG. 4 are still in a higher position than that illustrated, so that the spring 20 can be compressed to a greater or lesser extent by an upward and downward movement of the mandrel 28 and can thereby be prestressed. After the prestressing force F has been increased to more than 700 N, this force is gradually reduced again (cf. FIG. 5a) by the mandrel 28 from FIG. 4 being moved back upward. As soon as the nozzle needle 18 opens at a desired opening pressure p_{22S} in the first pressure space, the selected prestressing force F_{S} has been reached and the upward movement of the mandrel 28 is stopped. Then, the draw-in ram 50, and with it the prestressing element 26, are moved downward, with respect to FIG. 4, until the prestressing element 26 is locked in its selected position Y_{S}, by frictional locking with the spring chamber 30 based on the selected prestressing force F_{S}. After the prestressing element 26 has been locked in its selected position Y_{S}, in order to force the end portion 24 of the spring 20 into its selected position X_{S}, both the draw-in ram 50 and the mandrel 28 are removed.

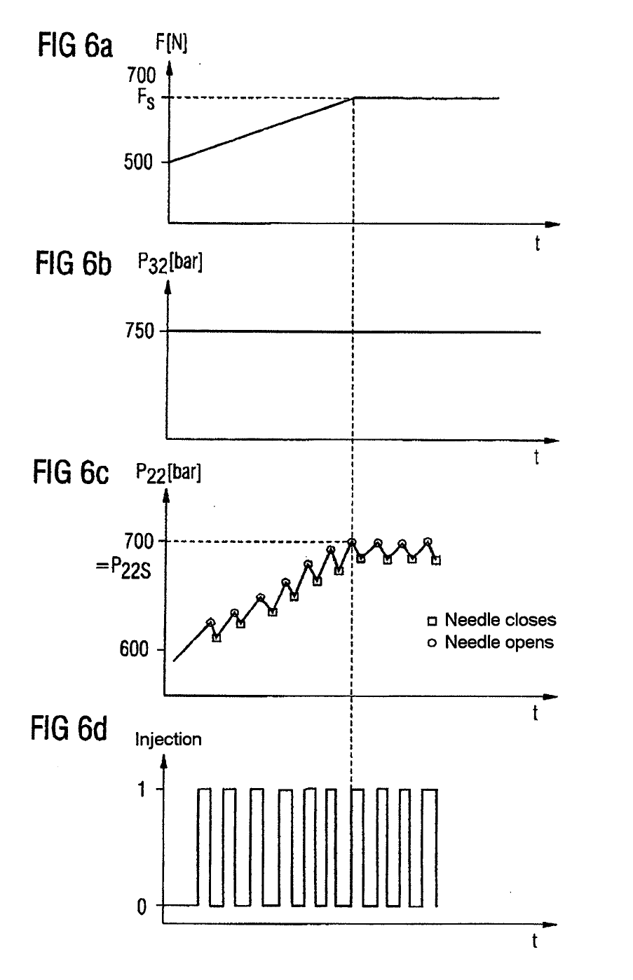

FIG. 6a shows a graph illustrating a possible profile of the prestressing force exerted on the spring as a function of time for a third embodiment of the method according to the invention, FIG. 6b shows a graph illustrating a possible profile for the pump pressure as a function of time for the third embodiment of the method according to the invention, FIG. 6c shows a graph illustrating a possible profile for the first pressure and the opening and closing characteristics of the nozzle needle as a function of time, for the force profile illustrated in FIG. 6a and the pressure profile illustrated in FIG. 6b, and FIG. 6d shows the injection characteristics of the pump-nozzle unit as a function of time, for the force profile illustrated in FIG. 6a and the pressure profile illustrated in FIG. 6b. In the embodiment of the method according to the invention which is illustrated in FIGS. 6a to 6d, the prestressing force F is altered continuously, in the present case increased, in accordance with the profile presented in FIG. 6a. Furthermore, in the case illustrated in FIG. 6b, the pressure p₃₂ which is preferably also generated externally in this case is 750 bar. By way of example under these conditions, the nozzle needle 18 starts to oscillate, i.e. the nozzle needle 18 opens and closes at short intervals (cf. FIG. 6c). This allows the desired opening pressure p_{22S} to be determined exclusively on the basis of the profile of the first pressure p₂₂. For this purpose, the prestressing force F can, for example, be increased continuously (cf. FIG. 6a) or in small steps until the desired opening pressure p_{22S} of, in the case illustrated, 700 bar is reached for the first time (cf FIG. 6c). This procedure can if desired be combined with the first embodiment illustrated in FIG. 2 and with the second embodiment illustrated in FIG. 4.

In all the embodiments in which the prestressing element 26 is locked by frictional locking, it is preferable for it to be the case, for the force F_{E} required to move the prestressing element 26, that F_{E}≧10*F_{S}, where F_{S} is the selected prestressing force to be set.

FIG. 7 diagrammatically depicts a prestressing element in the form of a sleeve or a slotted sleeve, FIG. 8 diagrammatically depicts a prestressing element in the form of a deep-drawn or extruded and perforated cup, and FIG. 9 diagrammatically depicts a prestressing element in the form of a conical stopper. Although this is not necessary in every case, all the embodiments of the prestressing element 26 illustrated have an aperture. An aperture of this type may be required, for example, if the spring chamber 30 is also filled with pressurized fuel from above, in order for a further closure force to be exerted on the nozzle needle 18.

The features of the invention which have been disclosed in the present description, in the drawings and in the claims may be pertinent to realization of the invention both on their own and in any desired combination.

We claim:

1. A method for setting the nozzle opening pressure of a pump-nozzle unit for feeding fuel into a combustion chamber of an internal combustion engine, the pump-nozzle unit having:
a fuel injection nozzle, which has a nozzle needle which can move in reciprocating fashion between a closed position and an open position,
a spring, which exerts a closure force, the level of which depends on a prestressing force exerted on the spring, on the nozzle needle, and
a first pressure space, to which a first pressure can be applied, with an opening force being exerted on the nozzle needle by the first pressure,
in which the following steps are carried out simultaneously:
applying a first pressure to the first pressure space,
varying the prestressing force exerted on the spring until a selected prestressing force, at which the nozzle needle moves into the open or closed position at the desired level of the first pressure, is reached, wherein the end portion of the spring is locked in the selected position by a prestressing element used in the pump-nozzle unit which forces the end portion of the spring into the selected position, the prestressing element is locked in a selected position in order to force the end portion of the spring into the selected position, and the prestressing element is locked in its selected position by frictional locking; and
wherein the prestressing element is designed as a conical stopper, and the prestressing element is arranged in a conical portion of the pump-nozzle unit.

2. A method according to claim 1, wherein an end portion of the spring is locked in a selected position which the end portion of the spring adopts when the selected prestressing force is exerted on the spring.

3. A method according to claim 1, wherein the dimensions of the prestressing element are suitable for forcing the end portion of the spring into the selected position.

4. A method according to claim 1, wherein the prestressing element is locked in its selected position by positive locking.

5. A method according to claim 1, wherein the prestressing element is deformed in order to achieve the frictional and/or positive lock.

6. A method according to claim 1, wherein the prestressing element is designed in the form of a sleeve or a slotted sleeve.

7. A method according to claim 1, wherein the prestressing element is designed in the form of a cup with a hole provided in its base.

8. A method according to claim 1, wherein the prestressing force is varied by changing the position of the prestressing element.

9. A method according to claim 1, wherein the prestressing force is varied by changing the position of a mandrel.

10. A pump-nozzle unit for feeding fuel into a combustion chamber of an internal combustion engine, comprising:
a fuel injection nozzle, which has a nozzle needle which can move in reciprocating fashion between a closed position and an open position, and
a spring, which exerts a closure force, the level of which depends on a selected prestressing force exerted on the spring, on the nozzle needle,
wherein the level of the selected prestressing force is dependent on a selected position of a prestressing element which is locked in the pump-nozzle unit, wherein the prestressing element forces an end portion of the spring into a selected position and wherein the prestressing element is locked in its selected position by frictional locking,
wherein the prestressing element is designed as a conical stopper, and the prestressing element is arranged in a conical portion of the pump-nozzle unit.

11. The pump-nozzle unit according to claim 10, wherein the prestressing element is deformed in order to achieve the frictional and/or a positive lock.

12. The pump-nozzle unit according to claim 10, wherein the prestressing element is designed in the form of a sleeve or a slotted sleeve.

13. The pump-nozzle unit according to claim 10, wherein the prestressing element is designed in the form of a cup with a hole in its base.

14. A method for setting the nozzle opening pressure of a pump-nozzle unit for feeding fuel into a combustion chamber of an internal combustion engine, the method comprising the steps carried out simultaneously:
applying a first pressure to the first pressure space, to which a first pressure can be applied, with an opening force being exerted on a nozzle needle of a fuel injection nozzle by the first pressure,
varying a prestressing force exerted on a spring for applying a closure force on the nozzle needle until a selected prestressing force, at which the nozzle needle moves into an open or closed position at the desired level of the first pressure, is reached, wherein an end portion of the spring is locked in a selected position by a prestressing element used in the pump-nozzle unit which forces the end portion of the spring into the selected position, the prestressing element is locked in a selected position in order to force the end portion of the spring into the selected position, and the prestressing element is locked in its selected position by frictional locking; and
wherein the prestressing element is designed as a conical stopper, and the prestressing element is arranged in a conical portion of the pump-nozzle unit.

15. A method according to claim 14, wherein an end portion of the spring is locked in a selected position which the end portion of the spring adopts when the selected prestressing force is exerted on the spring.

16. A method according to claim 14, wherein the dimensions of the prestressing element are suitable for forcing the end portion of the spring into the selected position.

17. A method according to claim 14, wherein the prestressing element is locked in its selected position by positive locking.

18. A method according to claim 14, wherein the prestressing element is deformed in order to achieve the frictional and/or positive lock.

19. A method according to claim 14, wherein the prestressing element is designed in the form of a sleeve or a slotted sleeve.

20. A method according to claim 14, wherein the prestressing element is designed in the form of a cup with a hole provided in its base.

21. A method according to claim 14, wherein the prestressing force is varied by changing the position of the prestressing element.

22. A method according to claim 14, wherein the prestressing force is varied by changing the position of a mandrel.
